(19) United States
(12) Patent Application Publication
(10) Pub. No.: US 2025/0369457 A1
(43) Pub. Date: Dec. 4, 2025

(54) System and Method for Controlling a Hydraulic Supply System on a Mobile Machine

(71) Applicant: AGCO International GmbH, Neuhausen (CH)

(72) Inventors: Martin Hiemer, Marktoberdorf (DE); Simon Walz, Marktoberdorf (DE); Thomas Harrer, Marktoberdorf (DE); Felix Janot, Marktoberdorf (DE)

(21) Appl. No.: 18/707,912

(22) PCT Filed: Nov. 15, 2022
(86) PCT No.: PCT/IB2022/060966

§ 371 Date: May 7, 2024

(30) Foreign Application Priority Data
Dec. 3, 2021 (GB) 2117522.9

(51) Int. Cl. E02F 9/22; F04B 49/06; F04B 49/08

(52) U.S. Cl. CPC E02F 9/2207; E02F 9/2235; F04B 49/065; F04B 49/08

(57) ABSTRACT

In an electronic load sensing system for adjusting a pump of a hydraulic supply system on a mobile machine, a pressure sensor forwards an electronic load sensing pressure signal ELSPS indicative of a sensed load sensing pressure LSP to a controller. The system's response to changes in load sensing pressure are damped with different dampening characteristics applied when the ELSPS is indicative of a rising load sensing pressure LSP than when it is indicative of a falling load sensing pressure LSP. The differing characteristics are selected to minimize the delay in adjusting the pump caused by the signal damping for a rising load sensing pressure while maintaining overall stability of the control system.

### CROSS-REFERENCE TO RELATED APPLICATIONS

This application is a national phase entry under 35 U.S.C. § 371 of International Patent Application PCT/IB2022/060966, filed Nov. 15, 2022, designating the United States of America and published in English as International Patent Publication WO 2023/099999 A1 on Jun. 8, 2023, which claims the benefit of the filing date of U. K. Patent Application 2117522.9 “System and Method for Controlling a Hydraulic Supply System on a Mobile Machine,” filed Nov. 15, 2022, the entire disclosure of which is incorporated herein by reference.

### FIELD

The disclosure relates to a control system for controlling a pressurized fluid supply system on a mobile machine. The control system is particularly applicable for use with a pressurized fluid supply system on a mobile agricultural machine, such as a tractor, which is capable of supplying pressurized fluid to consumers on the machine and to consumers on an agricultural implement attached to the machine. The disclosure also relates to a mobile machine, or to a combination of a mobile machine and attached implement, having such a control system, and to a method of controlling a pressurized fluid supply system on a mobile machine or on a mobile machine and attached implement combination.

### BACKGROUND

Pressurized fluid (hydraulic) supply systems are widely used to drive consumers on agricultural or construction mobile machines, e.g. a tractor or a self-propelled harvester, or on implements attached thereto. Such mobile machines will be referred to hereinafter simply as machines and are sometimes referred to as vehicles. These hydraulic systems are mostly provided with a pump supply, consumers, control means (respectively control valves) and a tank to provide a fluid reservoir. The term “consumer” is used in the further description to encompass hydraulic drives such as rotary motors or linear rams but also for the respective control valves assigned to these drives. The term “control” in relation to supply systems hereby includes any adjustment of the supply system regarding direction, supply time or pressure of the fluid flow or the delivery of the pump used to supply the system. The term “pump supply” includes the pump and all valve means which are needed to adjust the fluid flow and/or fluid pressure supplied by the pump to a pump supply line. The pressure of the fluid provided by the pump supply being referred to herein as the pump supply pressure PSP.

In a hydrostatic hydraulic system, a pressure differential is needed to provide hydrostatic work (an output). This pressure differential between the pump supply (source) and consumer results in a fluid flow which is sufficient to undertake work, such as to lift a tractor three-point hitch or a operate a rotary drive on an implement or in a hydrostatic drive for example. Furthermore, a stand-by or static pressure differential ΔPₛₜ is also needed when the system is otherwise in idle mode to keep control valves (assigned to consumers) responsive so that the spool of the valve can be moved on demand.

Hydraulic losses are present whenever oil circulates within a hydraulic system even when no consumer is operated. To mitigate this problem, it is known to provide means to forward a demand of a consumer to the pump supply. These systems are generally called load sensing systems (the term load sensing is abbreviated to LS). In such systems, a load induced pressure demand of the consumers, hereafter referred to as a “load sensing pressure” LSP, is hydraulically fed back to the pump supply via pipes or hoses so that pump supply oil flow/pressure can be adjusted according to the needs of the consumers. This load sensing pressure LSP feedback signal is typically generated by the control valve assigned to a consumer and the highest load sensing pressure LSP of all the consumers supplied by the pump is used to adjust the pump supply.

In general there are two different types of hydraulic supply systems with LS demand feedback available on the market: closed-center load sensing systems (CC-LS systems) and open-center load sensing systems (OC-LS systems).

CC-LS systems are equipped with variable displacement pumps whereby the demand of the consumers is hydraulically fed back to the pump supply including an adjustment means for the pump so that the displacement of the pump is adjusted according to the needs of the consumers.

To ensure that a stand-by pressure differential ΔPₛₜ is maintained in the supply to support fast system response, the pump is kept on low displacement to compensate for losses/leakage resulting in a stand-by pressure even if there is no demand by consumers. As a result of the reduction of the hydraulic fluid circulation, losses and power input required by the pump are reduced.

FIG. 1 illustrates part of a simplified known CC-LS hydraulic circuit. A pump supply 10 includes a variable displacement pump 12 which draws fluid from a tank 14 and forwards pressurized fluid to consumers (not shown) via a pump supply line P. Fluid is returned to the tank from the consumers via a return or tank line T. The pump 12 can be any suitable variable displacement pump and could, for example, be a swash plate axial piston pump in which the displacement of the pump is changed by pivoting the swash plate by means of a pump actuator 16 to vary the piston stoke. In the arrangement illustrated, actuator 16 is biased by a spring to pivot the swash plate in a direction to increase pump displacement and hence the output of the pump. Pressurized fluid introduced into a chamber 20 of the actuator opposes the force of the spring and if the force of the fluid is greater than that of the spring the swash plate is pivoted to reduce the delivery of the pump.

Operation of the actuator 16 is controlled by a flow control valve 22 and a pressure limiting valve 24, which together with the actuator 16 form a pump controller and form part of the pump supply 10. Each of the valves is biased by a respective spring 26, 28 to the position shown in which the actuator chamber 20 is connected to the tank 14. Each of the valves has a pump pressure port 30, 32 connected to the pressure line P of pump so that the fluid pressure acting on the valve spool through the pump pressure port 30, 32 opposes the force of the respective spring 26, 28. The flow control valve 22 also has a LS pressure port 34 to which a load sensing pressure signal line LS is connected. The highest consumer load sensing pressure LSP of the various consumers in the hydraulic LS system is fed into the LS pressure signal line so that the load sensing pressure LSP is added to the force of the spring to move the valve spool towards the position shown. The spring 26 in the flow control valve sets the stand-by pressure differential ΔPₛₜ which is typically in the region of 10 to 30 bar for tractor applications. The spring force may be adjustable to enable the stand-by pressure differential ΔPₛₜ to be adjusted. The spring 28 of the pressure limiting valve sets the maximum operating pressure of the system, which could be in the region 250 bar in the present example. Again, the spring force may be adjustable to enable the maximum operating pressure to be adjusted.

In normal operation when the system is at idle with no demand from the consumers, the pump supply pressure PSP acting through the pump pressure port 30 of the flow control valve 22 moves the spool against the force of the spring 26 to introduce pressurized fluid in to the chamber 20 of the actuator. This causes the actuator to pivot the swash plate and reduce the output of the pump until the pump supply pressure PSP balances the force of the spring 26 so that the output of the pump is held at the stand-by pressure ΔPₛₜ.

When a load sensing pressure signal LSP (or an increasing load sensing pressure signal) is reported to the LS pressure port 34 via the LS sensing line, this is added to the force of the spring 26 moving the valve spool so that the fluid pressure in the chamber 20 of the actuator is reduced. In response, the actuator 16 moves the swash plate to increase the output of the pump until the pump supply pressure PSP balances the force of the spring 26 and the load sensing pressure signal LSP. The pump therefore delivers a pump supply pressure PSP that is higher than the load sensing pressure LSP by the stand-by pressure differential ΔPₛₜ.

The pressure limiting valve 24 is usually held in the position shown by the spring 28 so that fluid passes into and out of the actuator chamber 20 under the control of the flow control valve 22. However, should the pump supply pressure PSP exceed the maximum permitted system pressure, as defined by the spring 28, the spool of the pressure limiting valve 24 is moved against the spring force to admit pressurized fluid into the chamber 20 of the actuator. This reduces the output of the pump until the pump supply pressure PSP it is brought back below the maximum permitted system pressure.

Generally, CC-LS systems are more expensive and complex than OC-LS systems but they have the advantage that the pump is only delivering above the stand-by pressure ΔPₛₜ on demand. This has a positive effect on the overall system efficiency. These systems are mainly used in high performance and high specification tractors (e.g. >100 kW) used to supply complex and powerful implements.

In contrast to CC-LS systems, OC-LS systems are provided with a fixed displacement pump. FIG. 2 illustrates part of a simplified OC-LS hydraulic circuit. A constant displacement pump 12′ draws hydraulic fluid from a tank 14 and delivers it to various consumers (not shown) via a pump supply or pressure line P. Fluid is returned to the tank 14 from the consumers via a return or tank line T. A proportional pressure compensator valve 40 forms part of the pump supply and is operative to selectively connect the pump supply line P to the tank 14. The spool of the valve 40 is biased by a spring 44 towards a closed position, as shown, in which pump supply line P is not connected to the tank. This spring sets a static or stand-by pressure differential ΔPₛₜ and the spring force may be adjustable to enable the stand-by pressure differential ΔPₛₜ to be adjusted. The pump supply pressure PSP is applied to the opposite end of the spool via a pressure port 46 to oppose the force of the spring. The valve also has an LS pressure port 48 through which a consumer load sensing pressure signal LSP is applied to the valve spool to act in addition to the spring force.

In an idle mode where there is no consumer demand, the pump supply pressure PSP opposes the spring force to open the valve and connect the pump supply line P to the tank. The pump supply pressure PSP in the pump supply line falls until it balances the spring force and is then held at the stand-by pressure differential ΔPₛₜ. If a consumer load sensing pressure signal LSP is forwarded to the valve 40 via the LS pressure port 48, this adds to the spring force tending to close the valve so that the pump supply pressure PSP increases until it balances the combination of the spring force and the load sensing pressure LSP. The pump supply pressure PSP is thereby held a level which is higher than the load sensing pressure LSP by the stand-by pressure differential ΔPₛₜ defined by the spring 44.

A further trend can be seen related to the supply and control means used on implements attached to an agricultural machine, such as a tractor. Due to increasing automation in agricultural work, implements are provided with more and more control functions which require complex control strategies. While in the past implements were equipped with only a few controllable drives (e.g. hydraulic cylinders or motors) which were controlled by valves on the tractor, today implements are provided with numerous controllable drives which cannot be controlled by the valves installed on the tractor. To address this, tractors are often equipped with power beyond systems (which may also be referred to in the art as high-pressure carry over). As the name suggests, these systems supply an uncontrolled (at the tractor) fluid flow from the pump supply to the implement via a respective interface, such as quick couplers. The implement itself is then equipped with control means in form of valves to adjust the parameters of the fluid supply. Similar to internal consumers on the tractor, these power beyond systems also include a LS function so that the load sensing pressure of consumers on the implement can be fed back to the pump supply on the tractor via a hydraulic LS line.

A typical power beyond interface 50 is illustrated in FIG. 1 and includes quick release hydraulic couplings 50a, 50b, 50c for releasably connecting a pump supply line P, a return or tank line T, and an LS signal line on the tractor to equivalent hydraulic lines Pi, Ti, LSi on the implement. As illustrated, the LS line (LS_{pb}) from the power beyond interface which reports a LS signal from the consumers on the implement and an LS line (LSₜ) which reports a LS signal from the consumers on the tractor are connected to the LS pressure port 34 on the flow control valve 22 though a shuttle valve 52 or another other functionally similar arrangement. This ensures that the highest LS load sensing pressure signal from the implement or the tractor is used to control the output of the pump. Where there are a number of consumers on the implement, shuttle valves are used to ensure the highest LS load sensing pressure signal LSP of the implement consumers is fed through to the power beyond LS connection 50c. Similarly, where there are a number of consumers on the tractor, shuttle valves or other functionally similar arrangements are used to feed the highest LS load sensing pressure signal LSP of the tractor consumers to the LSₜ line and hence to the shuttle valve 52.

A major advantage of the power beyond system is that the costs involved with fluid supply control are moved from the tractor to the implement so that a wider range of applications can be handled by tractors with reduced hydraulic control capability. These power beyond systems have mainly been the reserve of tractors with higher performance (>100 kW) and CC-LS systems. However, a demand has been recognized for smaller tractors with OC-LS systems to provide power beyond, for example vineyard tractors with about 70 KW have to provide a supply to complex implements such as fruit harvesters equipped with many hydraulic drives to be controlled.

A drawback with purely hydraulic LS arrangements is that the hydraulic load sensing pressure signal LSP has to be forwarded to the pump supply by hydraulic lines. Where the load sensing pressure signal LSP comes from a consumer on an implement, a coupling is required to releasably connect the implement hydraulic LS signal line with a hydraulic LS signal line on the tractor. Furthermore, the various hydraulic LS signal lines from different consumers must be connected via shuttle valves to ensure that the highest consumer load sensing pressure LSP is forwarded to the pump supply. This all involves considerable additional expense and takes up valuable installation space. To overcome these drawbacks, electrohydraulic load sensing (E-LS) arrangements have been developed.

U.S. Patent Application Publication 2007/0151238 A1, “Hydrostatic Drive System,” published Jul. 5, 2007, discloses a hydrostatic drive system in which a variable displacement pump controller is actuated electronically by an electronic control device. A pressure sensor is used to detect a hydraulic consumer load sensing pressure LSP and provides an input to the electronic control system. The electronic control system generates an electronic control signal for actuating the displacement pump controller via a LS control valve to set the pump supply pressure PSP so that it is higher than the sensed load sensing pressure LSP by a set amount ΔPₛₜ. The system avoids the need for lengthy hydraulic LS load sensing pressure signal lines.

German Patent 102014103932 B3, “Control Device for a Hydraulic Working Machine, Hydraulic System and Method for Controlling a Hydraulic System,” granted Jul. 23, 2015, discloses an E-LS system for an implement towed by a tractor. The towed implement has an electronic control device which determines the difference between the pump supply pressure PSP and the highest load sensing pressure LSP of the consumers on the towed implement. An electronic signal indicative of the pressure difference is forwarded to a hydraulic control module coupled to a LS connection of a variable displacement pump on the tractor. The hydraulic control module converts the electronic signal to a hydraulic control signal for controlling the pump displacement.

U.S. Patent Application Publication 2019/0345694 A1, “Hydraulic Control Arrangement for an Arrangement of Mobile Machines, and Arrangement of Mobile Machines,” published Nov. 14, 2019, discloses a further E-LS system for a tractor and towed implement which does not necessarily require an electronic controller on the implement. In the arrangement disclosed, a pressure sensor is provided on the tractor to detect a hydraulic LS load sensing pressure signal LSP provided by the implement via a power beyond LS coupling. The pressure sensor forwards an electronic load sensing pressure signal ELSPS representative of the hydraulic load sensing pressure LSP to an electronic control unit on the tractor which controls a transducer (e.g. a solenoid actuated pressure limiting valve) to provide a hydraulic pump supply control signal HPSCS having a pressure Pₛₑₜ for forwarding to a variable displacement pump controller. A further pressure sensor may be provided to forward an electronic load sensing pressure signal ELSPS representative of the highest load sensing pressure LSP of a number of consumers on the tractor. In this case, the electronic control unit selects the highest of the electronic load sensing pressure signals to use as a basis to control the transducer. The hydraulic pump supply control signal HPSCS output from the transducer may be connected with the pump controller via a shuttle valve, with a hydraulic load sensing pressure signal LSP from a steering system providing a further input to the shuttle valve. In this case, the highest pressure of the hydraulic pump supply control signal HPSCS from the transducer or the load sensing pressure LSP from the steering system is forwarded to the pump controller. This illustrates how E-LS and traditional hydraulic LS can be combined.

Arrangements for adjusting the pump supply pressure PSP in an E-LS system can be similar to those illustrated in either of FIGS. 1 and 2, except that a hydraulic pump supply control signal HPSCS for application to the LS pressure port 34, 48 of a flow control valve 22 or pressure compensator valve 40 is produced using a suitable transducer in dependence on an electronic pump supply control signal EPSCS from the controller. The transducer may be a solenoid-controlled pressure limiting valve, for example. The solenoid valve is actuated by the controller as a function of the hydraulic load sensing pressure demand LSP detected by a pressure sensor.

FIG. 3 illustrates how a pump supply 10 including a variable displacement pump 12 similar to that described above in relation to FIG. 1 can be adapted to incorporate a solenoid-controlled pressure limiting valve for use with an E-LS system. The pump supply 10 includes a flow control valve 22′ to control the flow of fluid between the pump supply line P, the chamber 20 of the pump control actuator 16 and the tank 14. As in the hydraulic LS system of FIG. 1, a spring 26 sets the stand-by or static pressure differential and is opposed by the pressure in the pump supply line P connected to the pressure port 30 of the flow control valve 22′. However, for use in an E-LS system, the fluid pressure Pₛₑₜ supplied to the LS pressure port 34 is set by a solenoid-controlled pressure limiting valve 54. When no current is provided to the solenoid 56 of the pressure limiting valve 54, the LS pressure port 34 is fully connected to the tank 14 and the pump supply pressure PSP at port 30 is opposed only by the force of the spring 26 in the flow control valve 22′ so that the pump output is maintained at the stand-by pressure ΔPₛₜ. When a consumer load sensing pressure LSP is detected by a pressure sensor and forwarded to a controller, the controller generates an electronic pump supply control signal EPSCS which is forward to the solenoid of the pressure limiting valve 54. The electronic pump supply control signal EPSCS actuates the pressure limiting valve 54 so that a hydraulic pump supply control signal HPSCS at a pressure Pₛₑₜ is applied at the LS port 34 of the flow control valve 22′ in addition to the spring force. This causes the pump displacement to be increased until the pump supply pressure PSP balances the combination of the spring force and the pressure Pₛₑₜ of the hydraulic supply control signal HPSCS.

As illustrated in U.S. Patent Application Publication 2019/0345694 A1, the hydraulic pump supply control signal HPSCS generated by the pressure limiting valve 54 may be forwarded to the LS port 34 via a shuttle valve with a conventionally generated hydraulic load sensing pressure signal LSP provided as second input to the shuttle valve. This arrangement enables an E-LS system to be integrated with a conventional hydraulic LS system.

For use with a fixed displacement pump arrangement such as that illustrated in FIG. 2, a solenoid actuated pressure limiting valve 54 can be used to generate a hydraulic pump supply control signal HPSCS for application to the LS pressure port 48 of the pressure compensator valve 40.

Other electronically controlled transducer arrangements can be used to convert an electronic pump supply control signal EPSCS into a hydraulic pump supply control signal HPSCS.

Though the known E-LS systems and methods work well and alleviate some of the problems of a purely hydraulic LS system, they have their own drawbacks. One issue the applicant has found is that E-LS increases the overall reaction time to adjust the pump supply pressure PSP in response to an increase in consumer load sensing pressure LSP. This can be explained by the fact that in a hydraulic LS system, the load sensing pressure signal LSP is forward by a generally static fluid column in the LS lines which immediately forwards a load sensing pressure demand. In electrohydraulic E-LS systems, the pressure sensors must communicate with the controller and the controller must communicate with the solenoid pressure limiting valve or other actuator for adjusting the pump supply pressure. This communication typically takes place over CAN or ETHERNET-BUS Networks. As a consequence, the electronic LS signal transfer depends on cycle times and these depend on the performance levels of the components. With the numerous electronic control systems used in agricultural machines today, the overall response time may be considerably higher compared to purely hydraulic LS systems. This problem is exacerbated if the pressure signals are dampened to avoid excessive oscillation/instability of the control system.

There is a need then for alternative systems and methods for controlling a hydraulic supply system on a mobile machine which overcome, or at least mitigate, some or all of the drawbacks of the known systems and methods.

There is in particular a need for alternative systems and methods for controlling a hydraulic supply system on a mobile machine which prevent excessive oscillation or instability without overly increasing reaction time.

### BRIEF SUMMARY

Aspects of the disclosure relate to a control system for controlling a hydraulic supply system of a mobile machine and/or of a mobile machine and attached implement combination, to a mobile machine and/or a mobile machine and attached implement combination, and to a method of controlling a hydraulic system of a mobile machine and/or of a mobile machine and attached implement combination.

In some embodiments, there is provided a mobile machine having a hydraulic supply system including at least one pump for supplying a pressurized fluid to a plurality of consumers on the mobile machine and/or an implement attached to the mobile machine, the mobile machine having a control system including an electronic load sensing (E-LS) system configured to regulate the output of the at least one pump in dependence load sensing pressures LSP reported by various consumers, wherein the E-LS system response to changes in load sensing pressure LSP is damped and wherein the system is configured to apply different damping characteristics depending on whether the load sensing pressure LSP is falling or rising.

In an embodiment, the E-LS system is configured such that no damping is applied when the load sensing pressure LSP is rising but damping is applied when the load sensing pressure LSP is falling.

In an embodiment, the E-LS system is configured such that damping is applied when the load sensing pressure LSP is rising and when it is falling, the E-LS system configured to apply a more aggressive damping when the load sensing pressure LSP is falling than when the load sensing pressure LSP is rising.

In some embodiments, there is provided a control system for controlling a hydraulic supply system on a mobile machine, wherein the hydraulic supply system includes a pump supply for supplying a pressurized fluid to a plurality of consumers on the mobile machine and/or an implement attached to the mobile machine. The control system comprising one or more controllers is configured to receive, from a pressure sensor of an electronic load sensing (E-LS) system associated with at least one of the consumers, a pressure signal indicative of a sensed load sensing pressure LSP associated with the at least one of the consumers; determine whether the load sensing pressure LSP is rising or falling; and compute and generate a control signal for regulating a pump supply pressure provided by the pump supply in dependence on the sensed load sensing pressure LSP. The one or more controllers are configured to dampen the control system response to changes in the load sensing pressure LSP, the one or more controllers being configured to apply different damping characteristics when the load sensing pressure LSP is rising than when the load sensing pressure LSP is falling.

The one or more controllers may collectively comprise an input (e.g. an electronic input) for receiving one or more input signals (e.g. the pressure signal) indicative of a sensed load sensing pressure LSP. The one or more controllers may collectively comprise one or more processors (e.g. electronic processors) operable to execute computer readable instructions for controlling operation of the control system, for example to determine the load sensing pressure LSP from a pressure signal received from a pressure sensor and/or to dampen the system response. The one or more processors may be operable to generate one or more control signals for controlling the pump supply pressure PSP. The one or more controllers may collectively comprise an output (e.g. an electronic output) for outputting the one or more control signals, such as a pump supply control signal EPSCS.

In an embodiment, the one or more controllers are configured to dampen the control system response to changes in the load sensing pressure LSP only when the load sensing pressure LSP is falling, such that the control system response to changes in the load sensing pressure LSP is undamped when the load sensing pressure is rising.

By dampening the system for a falling load sensing pressure LSP but not a rising load sensing pressure, there is no delay in raising the pump supply pressure in response to an increasing load demand introduced into the system by the damping. Damping the system response to a falling pressure signal will introduce some delay which may adversely affect overall efficiency but is acceptable to maintain stability of the control system.

In an embodiment, the one or more controllers configured to dampen the control system in response to changes in the load sensing pressure LSP more strongly when the load pressure sensing pressure LSP is falling than when the load sensing pressure LSP is rising.

By dampening the system less aggressively for a rising load sensing pressure LSP, any delay in raising the pump supply pressure in response to an increasing load demand introduced into the system by the damping is reduced in comparison to the delay when the load sensing pressure is falling. Though such dampening may adversely affect overall efficiency and dynamics, the degree of damping can be selected to achieve a balance between dynamic response and stability of the E-LS control system.

In an embodiment, the one or more controllers configured to dampen the control system response to changes in the load sensing pressure LSP by applying a digital low pass filter. The low pass filter may be a first order filter.

In an embodiment, the one or more controllers configured to dampen the control system response to changes in the load sensing pressure LSP by applying the following low pass filter when determining a target set pressure value Pₛₑₜ for adjusting the pump supply pressure in dependence on the load sensing pressure LSP:

$${P}_{set , n + 1} = {P}_{set , n} + \frac{Δ t}{Δ t + Tm} * ( K * {PLSP}_{, n + 1} - {P}_{set , n} ) n = ( 0 , 1 , 2 , … {n}_{max} ) ;$$

wherein:
P_{set,n}=the target set point pressure value Pₛₑₜ of the previous cycle;
P_{set,n}+1=the target set point pressure value Pₛₑₜ for the current cycle;
PLSPₙ₊₁=a pressure value based on or including the sensed load sensing pressure LSP of the current cycle;
Δt=cycle time;
Tm=time constant; and
K=constant.

In an embodiment, the one or more controllers are configured to apply a higher time constant Tm when the load sensing pressure LSP is falling than when the load sensing pressure LSP is rising.

In an embodiment, the following values/value ranges are adopted for a falling load sensing pressure LSP:
Δt=18 ms to 22 ms;
Tm=350 ms to 550 ms; and
K=1.

In an embodiment, the following values/value ranges are adopted for a rising load sensing pressure LSP:
Δt=18 ms to 22 ms;
Tm=45 ms to 55 ms; and
K=1.

In an embodiment, the one or more controllers may be configured to generate an electronic pump supply control signal EPSCS, the control system comprising a transducer for converting the electronic pump supply control signal EPSCS to a hydraulic pump supply control signal HPSCS for forwarding to a hydraulic pump supply adjustment system.

In an embodiment, the hydraulic system includes more than one consumer and more than one pressure sensor, each pressure sensor for sensing a load sensing pressure LSP associated with one or more of the consumers, in which case, the one or more controllers may be configured to receive pressure signals indicative of sensed load sensing pressure LSP from each of the pressure sensors and to adjust the pump supply pressure in dependence on the pressure signal indicative of the highest load sensing pressure LSP at any given time when operating in a load sensing mode for controlling the pump supply.

In an embodiment, the hydraulic system comprises at least one consumer on an implement attached to the mobile machine which is supplied with pressurized fluid from the pump supply on the mobile machine, in which case, the one or more controllers may be configured to receive, from a pressure sensor of a load sensing LS system associated with the at least one consumer on the implement, a pressure signal indicative of a sensed load sensing pressure LSP associated with the at least one consumer on the implement.

In an embodiment, the one or more controllers comprise at least a first controller on the mobile machine and a second controller on an implement attached to the mobile machine; the first and second controllers being in communication with one another.

In an embodiment, the pump supply includes a variable displacement pump having a pump controller including a flow control valve for regulating movement of an actuator to adjust the pump displacement. In this embodiment, the one or more controllers may be configured to generate an electronic pump supply control signal EPSCS, the control system comprising a transducer for converting the electronic pump supply control signal EPSCS to a hydraulic pump supply control signal HPSCS for forwarding to an LS pressure port of the flow control valve. The transducer may be a solenoid controlled pressure limiting valve.

In an embodiment, the pump supply includes a fixed displacement pump, the pump supply comprising a pressure compensator valve for selectively connecting a pump supply line to a reservoir (tank) to vary the pump supply pressure PSP. In this embodiment, the one or more controllers may be configured to generate an electronic pump supply control signal EPSCS, the control system comprising a transducer for converting the electronic pump supply control signal to a hydraulic pump supply control signal HPSCS for forwarding to an LS pressure port of the pressure compensator valve. The transducer may be a solenoid controlled pressure limiting valve. In some embodiments, there is provided a mobile machine comprising a hydraulic supply system including a pump supply for supplying a pressurized fluid to a plurality of consumers on the mobile machine and/or an implement attached to the mobile machine and a control system for controlling the hydraulic supply system according to the previous aspect as set out above.

In an embodiment there is more than one pump.

In some embodiments, there is provided a method of controlling a hydraulic supply system on a mobile machine, wherein the hydraulic supply system includes a pump supply for supplying a pressurized fluid to a plurality of consumers on the mobile machine and/or an implement attached to the mobile machine, the hydraulic supply system comprising an electronic load sensing (E-LS) system, the E-LS system configured to adjust the pump supply pressure in dependence on the sensed load sensing pressure LSP, wherein the method comprises dampening adjustment of the pump supply pressure PSP in response to changes in the load sensing pressure LSP, and wherein the method comprises applying different damping characteristics depending on whether the load sensing pressure LSP is rising or falling.

In an embodiment, the method comprising dampening adjustment of the pump supply pressure PSP in response to a falling load sensing pressure LSP and leaving adjustment of the pump supply pressure PSP in response to a rising load sensing pressure LSP undamped.

By damping the pressure signal for a falling load sensing pressure LSP but not a rising load sensing pressure, there is no delay in raising the pump supply pressure in response to an increasing load demand introduced into the system by the signal damping. Damping a falling pressure signal will introduce some delay which may adversely affect overall efficiency but is acceptable to maintain stability of the control system.

In an embodiment, the method comprises dampening adjustment of the pump supply pressure PSP in response to changes in the load sensing pressure LSP more strongly when the load pressure sensing pressure LSP is falling than when the load sensing pressure LSP is rising.

By dampening the system less aggressively for a rising load sensing pressure LSP, any delay in raising the pump supply pressure in response to an increasing load demand introduced into the system by the damping is reduced in comparison to the delay when the load sensing pressure is falling. Though such dampening may adversely affect overall efficiency and dynamics, the degree of damping can be selected to achieve a balance between dynamic response and stability of the E-LS control system.

In an embodiment, the method comprises dampening adjustment of the pump supply pressure PSP in response to changes in the load sensing pressure LSP by applying a digital low pass filter. The low pass filter may be a first order filter.

In an embodiment, the method comprises determining a target set point pressure value Pₛₑₜ for adjusting the pump supply pressure in dependence on the load sensing pressure LSP in accordance with the following low pass filter equation:

$${P}_{set , n + 1} = {P}_{set , n} + \frac{Δ t}{Δ t + Tm} * ( K * {PLSP}_{, n + 1} - {P}_{set , n} ) n = ( 0 , 1 , 2 , … {n}_{max} ) ;$$

wherein:
P_{set,n}=the target set point pressure value Pₛₑₜ of the previous cycle;
P_{set,n}+1=the target set point pressure value Pₛₑₜ for the current cycle;
PLSPₙ₊₁=a pressure value based on or including the sensed load sensing pressure LSP of the current cycle;
Δt=cycle time;
Tm=time constant; and
K=constant.

In an embodiment, the method comprises applying a higher time constant Tm when the load sensing pressure LSP is falling than when the load sensing pressure LSP is rising.

In an embodiment, the following values/value ranges are adopted for a falling load sensing pressure LSP:
Δt=18 ms to 22 ms;
Tm=350 ms to 550 ms; and
K=1.

In an embodiment, the following values/value ranges are adopted for a rising load sensing pressure LSP:
Δt=18 ms to 22 ms;
Tm=45 ms to 55 ms; and
K=1.

The method may comprise generating an electronic pump supply control signal EPSCS for adjusting the pump supply and using a transducer for converting the electronic pump supply control signal EPSCS to a hydraulic pump supply control signal HPSCS for forwarding to a hydraulic pump supply adjustment system.

In some embodiments, there is provided computer software comprising computer readable instructions which, when executed by one or more processors, causes performance of the method described above.

In some embodiments, a computer readable storage medium comprises the computer software described above. Optionally, the storage medium comprises a non-transitory computer readable storage medium.

Within the scope of this application it should be understood that the various aspects, embodiments, examples and alternatives set out herein, and individual features thereof may be taken independently or in any possible and compatible combination. Where features are described with reference to a single aspect or embodiment, it should be understood that such features are applicable to all aspects and embodiments unless otherwise stated or where such features are incompatible.

### BRIEF DESCRIPTION OF THE DRAWINGS

Embodiments will now be described, by way of example only, with reference to the further accompanying drawings, in which:

FIG. 1 illustrates part of a simplified known CC-LS hydraulic circuit;

FIG. 2 illustrates part of a simplified OC-LS hydraulic circuit;

FIG. 3 illustrates how a pump supply including a variable displacement pump can be adapted to incorporate a solenoid-controlled pressure limiting valve for use with an E-LS system;

FIG. 4 is a schematic side view of an agricultural machine and implement combination;

FIG. 5 is a schematic representation of a hydraulic system embodied in the combination of FIG. 4; and

FIG. 6 is a graph illustrating the effect of applying damping to a low pass filter to dampen the load sensing pressure.

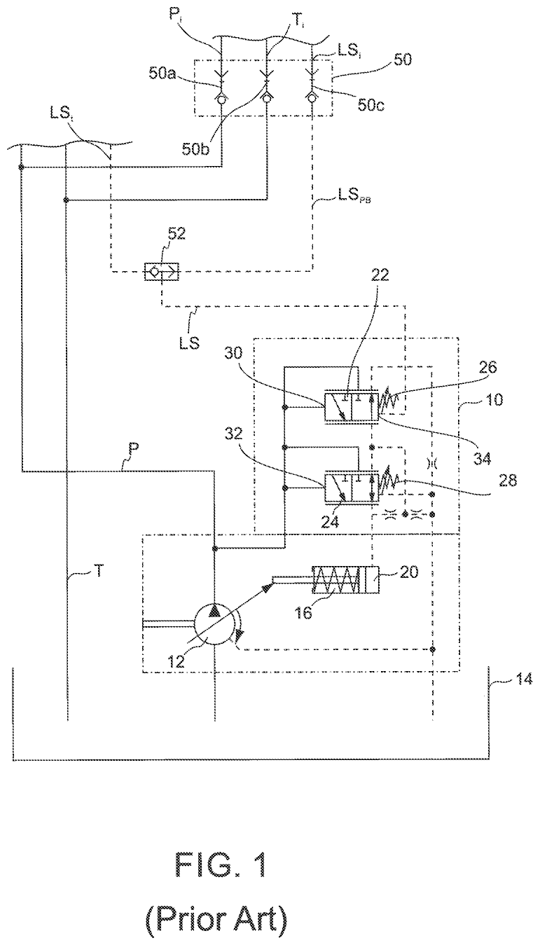

### DETAILED DESCRIPTION

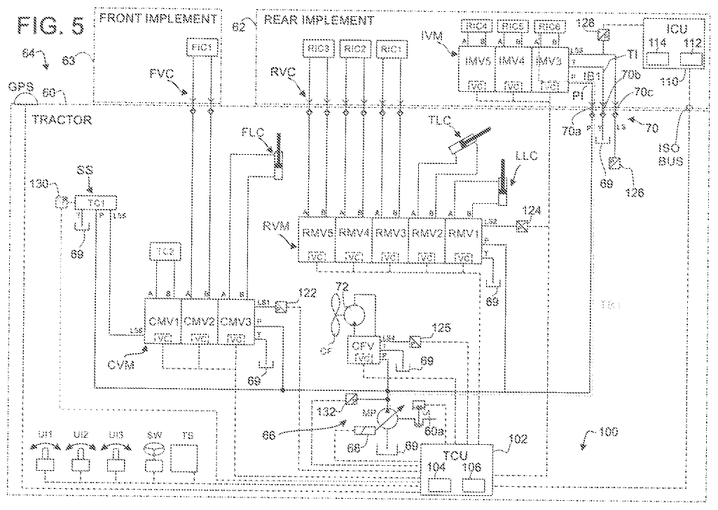

FIG. 4 illustrates a combination comprising a mobile agricultural machine 60 and an implement 62 attached to the rear of the machine. The implement 62 can be any suitable agricultural implement attachable to an agricultural machine having hydraulic consumers supplied with pressurized hydraulic fluid from a hydraulic supply system on the machine 60. The implement 62 will be referred to as a rear implement 62 and a further or alternative implement having hydraulic consumers fed by the supply on the machine, not shown in FIG. 4 but see FIG. 5, may be attached to the front of the tractor and will be referred to as a front implement 63.

The agricultural machine in the embodiment shown in the drawings and described below is specifically an agricultural tractor 60 and the rear implement 62 is a baler. Other types of agricultural implement commonly used with tractors include without limitation: a loading wagon, a towed sprayer, a plow, a row unit planter, and a towed potato harvester. Furthermore, the disclosure is not limited to application on tractors or other mobile agricultural machines but can be adapted for use with other mobile machines having a hydraulic supply system whether connected with an implement or not.

FIG. 5 is a simplified representation of a hydraulic supply system 64 suitable for use on the tractor 60 and implement 62, 63 combination. The hydraulic supply system 64 incorporates an E-LS system and is configured as disclosed herein.

### Hydraulic Network

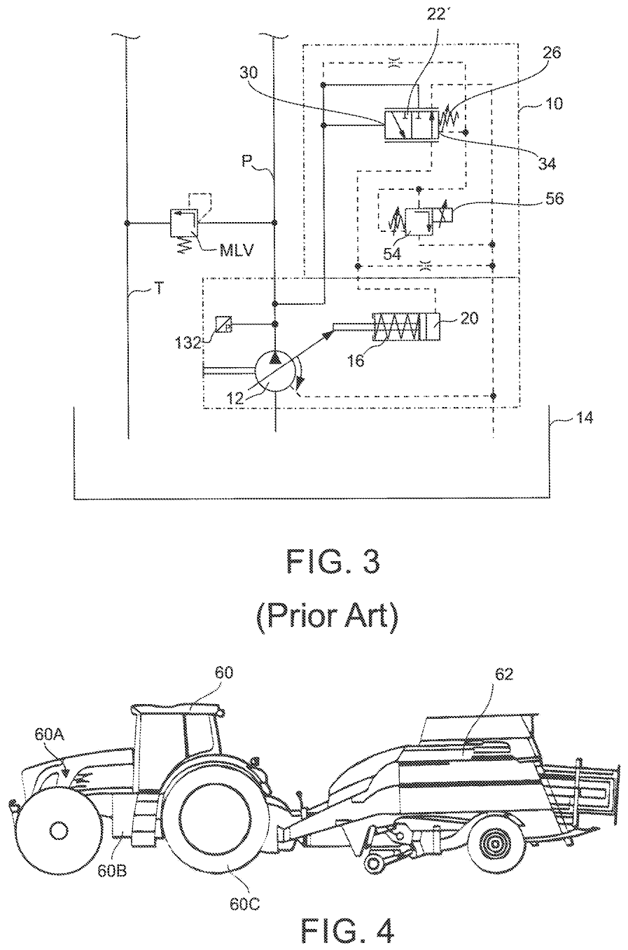

The hydraulic supply system 64 has pump supply 66 including main pump MP which is of variable displacement type and a pump output controller 68 for adjusting the displacement of the pump. In an embodiment, the pump output controller 68 is configured in a manner similar to that illustrated in FIG. 3. However, in other embodiments, alternative pump output controller arrangements can be adopted including any of those currently used with E-LS systems which enable an electronic controller to regulate and adjust the flow and/or pressure output of the pump supply 66.

The pump MP draws fluid from a tank 69 and supplies pressurized hydraulic fluid at a pump supply pressure PSP to consumers on the tractor and the implement via a pump supply line P. The tank 69 provides a reservoir for the hydraulic supply system in which the fluid is held generally at ambient pressure. The tank 69 is illustrated schematically in FIG. 5. In practice in any given hydraulic supply system 64 there may a single tank 69 or multiple tanks 69.

The consumers on the tractor 60 include a hydraulic steering system SS, a central valve manifold CVM, and a rear valve manifold RVM.

The steering system SS may include a hydraulic cylinder and control valve designated tractor consumer TC1 for moving the steered wheels. The control valve is connected to the pump supply line via a pressure port P and to the tank via a tank port T.

The central valve manifold CVM is installed generally in the middle of the tractor and includes a number of functional valves for controlling a corresponding number of hydraulic consumers located usually in or towards the middle and front area of the tractor. In the example illustrated, the central valve manifold CVM includes three functional valves CMV1, CMV2, CMV3 assembled together and connected to the pump supply line via a common pressure port P and to a return line to the tank at a common return port T. Each valve is assigned to a specific consumer and the valves CMV1, CMV2, CMV3 may have different configurations (e.g., ON/OFF, proportional valves, 3/2 valves, 4/2 valves) according to the functional needs of their respective consumer. The valves CMV1, CMV2, CMV3 are solenoid valves and each has a valve controller VC for controlling the solenoid. The number and configuration of the valves in the CVM may be varied to meet the requirements of the tractor manufacturer and/or the end customer. There may, for example, be more or fewer than three functional valves in the CVM.

The CVM has a common load sensing port LS1 and each of the valves CMV1, CMV2, CMV3 have LS ducts connected to the common LS port LS1 by means of shuttle valves so that the highest load sensing pressure LSP generated by the various valves CMV1, CMV2, CMV3 at any given point in time is forwarded to the LS port.

The CVM can be used to supply hydraulic fluid to various consumers such as, without limitation, a front linkage actuator FLC and an axle suspension system indicated as tractor consumer TC2. Valves in the CVM can also be used to supply consumers on a front implement 63 attached to the tractor indicated as FIC1. Each consumer on the front implement 63 being hydraulically connected to a respective valve CMV2 via front valve couplings FVC.

The RVM is installed in the rear of the tractor and is provided to supply consumers which are mainly in the rear area of the tractor and/or on a rear implement 62. The RVM is similar to the CVM in terms of design and variability and contains a number of functional valves indicated as RMV1 to RMV5 assembled together and connected to the pump supply line via a common pressure port P and to a return line to the tank at a common return port T. At least some of the valves in the RVM may be used to supply consumers on a rear implement 62 and/or on the tractor 60. In the exemplary embodiment illustrated, three of the valves, RMV3, RMV4, and RVM5, are connected with respective consumers RIC1, RIC2, RIC3 on the rear implement 62 via rear valve couplings RVC. The RVC may be directly flanged to the RVM as described in European Patent Application Publication 2886926 A1, “Hydraulic Coupling Seal,” published Jun. 24, 2015. As it is common to attach complex implements to the rear of a tractor, there may be more than three valves in the RVM for connection to consumers on a rear implement 62. There may, for example, be as many as six, seven, eight or more valves in the RVM assigned for connection to consumers on rear implements. At least some of the valves in the RVM may be assigned to consumers located at or towards the rear of the tractor such as actuators on a rear linkage system. In the exemplary embodiment shown, valve RMV1 is assigned to a pair of lower link hydraulic cylinders LLC being supplied in parallel and valve RMV2 is assigned to a hydraulically driven top link actuator cylinder TLC. In an alternative embodiment, the top link actuator may be a mechanical actuator and the valve RMV2 used for other purposes.

Each valve RMV1 to RMV5 in the RVM is a solenoid actuated valve and is provided with a valve controller VC which moves the solenoid and provides a pilot pressure. Each valve is configured according to the requirements of its respective consumer (e.g., ON/OFF, proportional valves, 3/2 valves, 4/2 valves).

The RVM has a common load sensing port LS2 and LS ducts of the valves RMV1, RMV2, RMV3, RMV4, RMV5 are all connected to the common LS port LS2 by means of shuttle valves so that the highest load sensing pressure LSP generated by the various valves at any given point in time is forwarded to the common LS port LS2.

As with the CMV, the RVM can be configured to have any required number and configuration of valves depending on the number and requirements of the hydraulic consumers on the tractor and any implements that are expected to be attached to the tractor. It should be understood, therefore, that the configuration of the CVM and RVM shown in FIG. 5 is for illustrative purposes only and can be varied.

The hydraulic supply system 64 includes a power beyond interface 70 to provide an “uncontrolled” supply of pressurized fluid to a rear implement 62 which requires more hydraulic functions than can be controlled using the available valves on the tractor. Such a complex implement 62 may be a baler, for example. The power beyond interface 70 includes quick release couplings 70a, 70b to connect the pump supply line P and a return tank line T on the tractor to a pump pressure supply line PI and a return line TI respectively on the implement 62. The power beyond interface provides a pressurized fluid supply to an implement which is at the pump supply pressure PSP but which is otherwise uncontrolled on the tractor.

In a typical arrangement, the rear implement 62 has an implement valve manifold IVM similar to the CVM and RVM as described above. The IVM has a number of functional control valves IMV1 to IMV3 which are each connected to the implement pump supply pressure line PI through a common pressure port P and to the implement return line TI via a common return port T. The IVM also has a common LS pressure signal port LS3 to which LS ducts of each of the valves IMV1 to IMV3 are connected via a series of shuttle valves arranged so that the highest consumer load sensing pressure LSP from the various valves in the IVM at any given point in time is reported to the common LS port LS3. Each valve IMV1 to IMV3 is connected to a respective consumer (e.g. a hydraulic cylinder or hydraulic motor) which are schematically designated RIC4 to RIC6. Each valve is configured according to the requirements of its respective consumer (e.g., ON/OFF, proportional valves, 3/2 valves, 4/2 valves). The valves are all solenoid-controlled valves and each is provided with an electronic valve controller VC which moves the solenoid and provides a pilot pressure (supplied via pump connection to support the valve slider movement).

The number of valves in the IVM is selected depending on the number of consumers on the implement that are to be supplied via the power beyond interface and can be varied as required. Furthermore, there may be more than one valve manifold on the implement and/or one or more separate valves not incorporated into a manifold can be connected to the power beyond interface via suitable hydraulic lines.

In the embodiment shown, the tractor has a further hydraulic consumer in the form of a hydraulic motor 72 for driving a cooling fan CF. The hydraulic motor 72 is controlled by a cooling fan valve CFV which regulates the cooling fan motor to vary the speed of the fan. The CFV is a solenoid-controlled valve having an electronic valve controller VC which is operably connected with an electronic controller 102 on the tractor. The controller is configured to actuate the CFV in order to adapt the motor speed to the cooling demand.

As illustrated in FIG. 3, the hydraulic supply system may also be provided with a main pressure limiting valve MLV which opens to vent the pump supply P to the tank 69 if the pressure exceeds a predetermined pressure. The MLV is set to open at a pressure above the maximum permitted operating pressure of the system. This provides an additional level of safety in case the limitation of the pump supply pressure PSP through the pump controller should fail. For use with current tractor hydraulic supply systems, the MLV may be set to open a pressure value of around 250 bar, for example. However, the pressure at which the MLV opens can be selected as appropriate for any given system.

The hydraulic supply system 64 illustrated in FIG. 5 is exemplary only and can be modified for use with hydraulic supply systems which have alternative layouts, including an alternative number and type of consumers and control valves. For example, the tractor 60 may have more than one pump and may have a fixed displacement pump in addition to the main pump MP for supplying other consumers such as a lubrication system for the driveline, a transmission (of hydrostatic-mechanical split type) or a hydraulic brake system, for example. These are not shown in FIG. 5 as they are not included in the E-LS control arrangements which are the subject of the present disclosure.

### Electronic Network

FIG. 5 also illustrates an electronic control system network 100 for the hydraulic supply system 64. As shown, the control network 100 includes a controller 102 on the tractor having an electronic processor 104. The processor 104 is operable to access a memory 106, which may be part of the controller 102, and execute instructions stored therein to perform the steps and functionality disclosed. The memory 106 may include any one or a combination of volatile memory elements (e.g., random-access memory RAM, such as DRAM, and SRAM, etc.) and non-volatile memory elements (e.g., ROM, hard drive, tape, CDROM, etc.). The memory 106 may store a native operating system, one or more native applications, emulation systems, or emulated applications for any of a variety of operating systems and/or emulated hardware platforms, emulated operating systems, etc. The memory 106 may furthermore store parameters or settings needed to operate the control systems and/or perform the methods as described below.

It should be appreciated by one having ordinary skill in the art that in some embodiments, additional or fewer software modules (e.g., combined functionality) may be stored in the memory 106 or in additional memory. In some embodiments, a separate storage device may be coupled to the data bus, such as a persistent memory (e.g., optical, magnetic, and/or semiconductor memory and associated drives). In a further embodiment, the memory 106 may be connectable with an off-board network architecture (via mobile communication or WLAN) to provide parameters or settings.

The processor 104 may be embodied as a custom-made or commercially available processor, a central processing unit (CPU) or an auxiliary processor among several processors, a semiconductor based microprocessor (in the form of a microchip), a macro processor, one or more application specific integrated circuits (ASICs), a plurality of suitably configured digital logic gates, and/or other well-known electrical configurations comprising discrete elements both individually and in various combinations to coordinate the overall operation of the controller 102.

Electronic communications among the various components of the control network 100, as indicated by the dashed lines, may be achieved over a controller area network (CAN) bus or via a communications medium using other standard or proprietary communication protocols (e.g., RS 232, Ethernet, etc.). Communication may be achieved over a wired medium, wireless medium, or a combination of wired and wireless media.

The controller 102 is in communication with each of the electronic solenoid valve controllers VC of the various valves on the tractor, with the pump output controller 68, and with various user interfaces such as a steering wheel SW, valve rockers represented as UI1 and UI2, a linkage control represented as UI3, and a touch screen TS. The touch screen is typically located within a cab of the tractor to provide information to the driver and receive input (e.g. to select, adjust and/or save settings). The touch screen TS may alternatively be replaced or enhanced by a keyboard to receive input. Indeed, any input or presentation of information whether by manual, speech or gestures may be included herein. Each user interface UI may be permanently assigned to one consumer of the tractor or the implement. Alternatively, one or more of the user interfaces may be variably assignable to any one of two or more consumers by the operator. Such an assignment might be effected via the touch screen, for example.

The controller 102 may also receive further data, such as from a GPS receiver to determine the current position of the tractor, and/or may be operative to control further devices.

The rear implement 62 may also be connected to the tractor controller 102, such as via a standardized agricultural ISOBUS for example, to exchange data and control between the implement and tractor as described later on. For this purpose, the implement 62 may be provided with an implement controller 110 which communicates with the tractor controller 102. Where present, an implement controller 110 may have an electronic processor 114 which is operable to access a memory 112 of the implement controller 110 and execute instructions stored therein to perform the steps and functionality disclosed.

The memory 112 may include any one or a combination of volatile memory elements (e.g., random-access memory RAM, such as DRAM, and SRAM, etc.) and non-volatile memory elements (e.g., ROM, hard drive, tape, CDROM, etc.). The memory 112 may store a native operating system, one or more native applications, emulation systems, or emulated applications for any of a variety of operating systems and/or emulated hardware platforms, emulated operating systems, etc. The memory 112 may furthermore store parameters or settings needed to operate the control systems as described below.

It should be appreciated by one having ordinary skill in the art that in some embodiments, additional or fewer software modules (e.g., combined functionality) may be stored in the memory 112 or additional memory. In some embodiments, a separate storage device may be coupled to the data bus, such as a persistent memory (e.g., optical, magnetic, and/or semiconductor memory and associated drives). In a further embodiment, the memory 112 may be connectable with an off-board network architecture (via mobile communication or WLAN) to provide parameters or settings.

The processor 114 may be embodied as a custom-made or commercially available processor, a central processing unit (CPU) or an auxiliary processor among several processors, a semiconductor based microprocessor (in the form of a microchip), a macro processor, one or more application specific integrated circuits (ASICs), a plurality of suitably configured digital logic gates, and/or other well-known electrical configurations comprising discrete elements both individually and in various combinations to coordinate the overall operation of the controller 102.

### Load Sensing

Returning to the hydraulic supply system, at any given time, a highest of the load sensing pressure demands LSP from the consumers on the tractor 60 and any attached implements 62 is used to regulate the pump output controller 68 by means of a load sensing LS system. The load sensing system includes an electronic (electrohydraulic) load sensing (E-LS) system including a number of pressure sensors for sensing load sensing pressure demand signals LSP from consumers which are part of the E-LS system. Each of the pressure sensors is in communication with a controller 102 or 110 and forwards to the controller an electronic load sensing pressure signal ELSPS (a pressure signal) representative of the sensed consumer load sensing pressure LSP.

The electronic load sensing pressure signal ELSPS may be an analogue signal in which a characteristic of the signal is modulated in dependence on the pressure of the hydraulic load sensing pressure signal LSP. In an embodiment, the current of the ELSPS is modulated in dependence on the pressure of the hydraulic load sensing pressure signal LSP but in another embodiment it is the voltage. In an embodiment where the ELSPS is an analogue signal, the controller 102, 110 converts the ELSPS into a pressure value by reference to data stored in the controller (or to which the controller has access) which provides a correlation between the modulated characteristic and pressure for the sensed load sensing pressure LSP. This data may be provided in the form of a characteristic map or a look up table assigned to the sensor. In another embodiment, the pressure sensor has a CPU and communicates with the controller through a CAN interface. In this case, conversion of the analogue signal to a pressure value is made at the sensor and the pressure value forwarded to the controller 102, 110.

In the embodiment illustrated, a first pressure sensor 122 is connected with the LS port LS1 on the CVM where it is subject to the highest consumer load sensing pressure signal LSP of the valves in the CVM. A second pressure sensor 124 is connected with an LS port LS2 on the RVM where it is subject to the highest consumer load sensing pressure signal LSP of the valves in the RVM. A third pressure sensor 125 is connected with an LS port LS4 on the cooling fan valve CFV to sense the load sensing pressure of the cooling fan motor.

A fourth pressure sensor 126 on the tractor is connected with a LS coupling 70c of the power beyond interface. On the implement, the LS power beyond coupling may be hydraulically connected with the common LS port LS3 of the IVM so that the highest load sensing pressure demand LSP from the various valves in the IVM is forwarded to the fourth pressure sensor 126 when the implement is coupled to the tractor. However, for implements which have a controller 112, an implement pressure sensor 128 can be connected with the common LS port LS3 of the IVM. In this case, the implement pressure sensor 128 communicates with the implement controller 112 and forwards to the implement controller 112 an electronic load sensing pressure signal ELSPS representative of the sensed consumer load sensing pressure LSP at the IVM common LS port LS3. The implement controller 112 forwards data relating to the sensed load demand pressure LSP to the tractor controller 102. The implement controller 110 may process the load sensing pressure demand data and forward to the tractor controller 102 data which is modified or a signal which is a function of the sensed load sensing pressure signal LSP.

The load sensing pressure demand LSP of the steering system is also sensed electronically to form part of the E-LS system. FIG. 5 illustrates two alternative arrangements. In one embodiment, an LS port LS5 of the steering system actuator/control valve TC1 is hydraulically connected by a LS signal line to an LS input port LS6 on the CVM. The LS input port LS6 is connected together with the LS ducts of each of the valves in the CVM to the common LS port LS1 by a suitable cascade of shuttle valves so that the highest load sensing pressure demand LSP from the steering system and the various valves CMV1 To CMV3 is reported to the common LS port LS1 to be sensed by the first pressure sensor 122. In an alternative embodiment, a dedicated pressure sensor 130 is provided to sense the load demand pressure LSP of the steering system. The steering system pressure sensor 130 may be hydraulically connected to the LS port of the steering system and electronically connected to the tractor controller 102 to forward to the controller an electronic load sensing pressure signal ELSPS representative of a sensed consumer load sensing pressure LSP of the steering system.

The tractor controller 102 is configured to select an electronic load sensing pressure signal ELSPS representative of the highest consumer load sensing pressure LSP forwarded to it, either directly from a pressure sensor or from the implement controller 112. The controller processes the selected signal and forwards an electronic pump supply control signal EPSCS to the output controller 68 of the main pump MP to vary the output of the pump MP in dependence on the highest sensed load sensing pressure LSP. Where the pump output controller 68 comprises a solenoid controlled pressure limiting valve 54 as illustrated in FIG. 3, the tractor controller 102 forwards an electronic pump supply control signal EPSCS to actuate the solenoid of the pressure limiting valve 54 in order to vary the output of the main pump. Typically, the current of the electronic pump supply control signal EPSCS will determine the extent of movement of the solenoid and so will determine the pressure Pₛₑₜ of the resulting hydraulic pump supply control signal HPSCS applied to the LS port 34 of the flow control valve 22′ and hence the supply pressure PSP of the main pump. The resulting pump supply pressure PSP can be calculated by equation 1:

$$PSP = Δ {P}_{st} + {P}_{set} \qquad Equation 1$$

Where ΔPₛₜ is the static or stand-by pressure differential defined by the spring 26 in the flow control valve 22′, and Pₛₑₜ is the pressure of the hydraulic pump supply control signal HPSCS provided at the LS pressure port of the flow control valve.

Where the implement has an electronical controller 110, communication between the tractor controller 102 and electronic components of the LS pressure control system on the implement, such as valve controllers VC and pressure sensors 128 of the IVM, is typically made via the implement controller 110, with data and instructions being transmitted between the implement controller 110 and the tractor controller 102 via a standardized ISOBUS connection.

In an embodiment, the controller 102 converts a target pressure value for Pₛₑₜ to a current value for forwarding to the solenoid-controlled pressure limiting valve 54 (or other transducer) as an analogue electronic pump supply control signal EPSCS. In another embodiment, the pump output controller 68 has a CPU and communicates with the controller 102 through a CAN interface. In this case, the controller 102 forwards the target set point pressure value Pₛₑₜ to pump controller 66 in an electronic pump supply control signal EPSCS through a CAN interface and the pump CPU converts the pressure value to an analogue signal for controlling the pressure limiting valve 54 or other transducer.

Conversion of the target pressure value for Pₛₑₜ to a current value may be made by reference to data which provides a correlation between a current value and the resulting pressure Pₛₑₜ generated by the solenoid-controlled pressure limiting valve 54 or other transducer. This data may be stored in, or is otherwise accessible to, the controller 102 or pump controller CPU and may be provided in a characteristic map or a look up table assigned to the valve 54 and/or the pump MP for example. In other embodiments it may be a voltage of the analogue which is modulated to control the output of the solenoid-controlled pressure limiting valve 54.

The pressure sensors, the one or more controllers 102, 110, and the pump output controller 68 can all be considered as part of a control system for the hydraulic supply system.

### Pressure Differential Set in Dependence on the Rate of Increase of Load Pressure Demand LSP

In accordance with an embodiment, the tractor controller 102 is programmed and configured to control adjustment of the output of the main pump MP in dependence not only on the value of the sensed load sensing pressure LSP but also in dependence on the rate of change of an increasing load sensing pressure demand LSP (referred to as the LSP pressure gradient).

In accordance with a suitable algorithm, the tractor controller 102 determines the LSP pressure gradient of a highest of the load sensing pressure signals LSP forwarded to it by the various pressure sensors in the E-LS network. If the LSP pressure gradient is below a threshold value Tr, the controller 102 regulates the main pump output so that the supply pressure PSP is maintained above the load sensing pressure LSP by a first differential. In an embodiment, the first differential is the stand-by or static pressure differential ΔPₛₜ defined by the spring 26 in the flow control valve 22′ and the tractor controller 102 forwards an electronic pump supply control signal EPSCS to the pressure limiting valve 54 calibrated to generate a hydraulic pump supply control signal HPSCS having a pressure Pₛₑₜ that is the same as (or equivalent to) the load demand pressure LSP. The resulting pump supply pressure PSP under this circumstance can be derived from equation 1 where Pₛₑₜ=LSP so that equation 1 can be re-written as:

$$PSP = Δ {P}_{st} + LSP \qquad Equation 2$$

Accordingly, when the rate of change of an increasing consumer load sensing pressure LSP is below the threshold value Tr, the E-LS system operates broadly in the same manner as a conventional E-LS system. However, when the rate of increase of a consumer load sensing pressure LSP is at or above the threshold value Tr, the controller 102 is programmed and configured to regulate the main pump output so that the supply pressure PSP is maintained above the load sensing pressure LSP by a second differential larger than the first pressure differential ΔPₛₜ. The second pressure differential can be considered to be made up of the static or stand-by pressure differential ΔPₛₜ regulated by the spring 26 in the flow control valve 22′ plus an additional dynamic pressure differential ΔP_{dyn} which is applied by the controller 102 through the hydraulic pump supply control signal HPSCS generated by the pressure limiting valve 54. In this case, the tractor controller 102 forwards to the pressure limiting valve 54 an electronic pump supply control signal EPSCS calibrated to generate a hydraulic pump supply control signal HPSCS having a pressure Pₛₑₜ that is higher than the load demand pressure LSP by the amount of the dynamic pressure differential ΔP_{dyn}, such that Pₛₑₜ is equal to the load demand pressure LSP plus the dynamic pressure differential ΔP_{dyn} (Pₛₑₜ=LSP+ΔP_{dyn}). Equation 1 in this case can be re-written as:

$$PSP = {P}_{st} + LSP + Δ {P}_{dyn} \qquad Equation 3$$

By providing an increased pressure differential when the rate of increase of the load sensing pressure LSP is at or above a certain threshold Tr, the dynamic response of the system is increased. The dynamic pressure differential ΔP_{dyn} may be applied for a set time period once it is triggered as discussed below.

In a first example, ΔPₛₜ is set at 20 bar, the threshold value Tr of the LSP pressure gradient is set at 5 bar/50 ms (a pressure increase of 5 bar in 50 ms), and the dynamic pressure differential ΔP_{dyn} is set at 20 bar.

The following tables compare the dynamic performance of a conventional E-LS system and an E-LS system in accordance with the embodiment described above when a consumer valve is opened to produce a consumer load sensing pressure LSP rapidly increasing to 140 bar. Table 1 below illustrates a typical dynamic response of a conventional E-LS control system in these circumstances.

TABLE 1
pressure differential increased by LSP in accordance with prior art

| | | PSP = ΔPₛₜ + Pₛₑₜ | | |
|---|---|---|---|---|
| | | (where Pₛₑₜ = LSP) | | |
| | | | LSP at | PSP at |
| | | | start of | end of |
| | | ΔPₛₜ | cycle | cycle |
| Cycle | Description | (bar) | (bar) | (bar) |
| 1 | Pump pressure is 20 bar, valve is | 20 | 20 | 40 |
| | actuated. Pₛₑₜ = | | | |
| | 20 bar (LSP) is | | | |
| | forwarded to pump | | | |
| | controller, pump supply | | | |
| | pressure is adjusted to 40 bar | | | |
| 2 | Pump pressure is 40 bar, valve is | 20 | 40 | 60 |
| | actuated. Pₛₑₜ = | | | |
| | 40 bar (LSP) is | | | |
| | forwarded to pump | | | |
| | controller, pump supply | | | |
| | pressure is adjusted to 60 bar | | | |
| 3 | Pump pressure is 60 bar, valve is | 20 | 60 | 80 |
| | actuated. Pₛₑₜ = | | | |
| | 60 bar (LSP) is | | | |
| | forwarded to pump | | | |
| | controller, pump supply | | | |
| | pressure is adjusted to 80 bar | | | |
| 4 | Pump pressure is 80 bar, valve is | 20 | 80 | 100 |
| | actuated. Pₛₑₜ = | | | |
| | 80 bar (LSP) is | | | |
| | forwarded to pump | | | |
| | controller, pump supply | | | |
| | pressure is adjusted | | | |
| | to 100 bar | | | |
| 5 | Pump pressure is 100 | 20 | 100 | 120 |
| | bar, valve is | | | |
| | actuated. Pₛₑₜ = | | | |
| | 100 bar (LSP) is | | | |
| | forwarded to pump | | | |
| | controller, pump supply | | | |
| | pressure is adjusted | | | |
| | to 120 bar | | | |
| 6 | Pump pressure is 120 bar, valve is | 20 | 120 | 140 |
| | actuated. Pₛₑₜ = | | | |
| | 120 bar (LSP) is | | | |
| | forwarded to pump | | | |
| | controller, pump supply | | | |
| | pressure is adjusted | | | |
| | to 140 bar | | | |
| 7 | Pump pressure is 140 bar, valve is | 20 | 140 | 160 |
| | actuated. Pₛₑₜ = | | | |
| | 140 bar (LSP) is | | | |
| | forwarded to pump | | | |
| | controller, pump supply | | | |
| | pressure is adjusted | | | |
| | to 160 bar | | | |

As illustrated in Table 1, at each cycle the pressure Pₛₑₜ of hydraulic pump supply control signal HPSCS forwarded to the pump controller is equal to the consumer load sensing pressure signal LSP at that time. In the arrangement illustrated, it takes seven cycles for the system to increase the pump supply pressure PSP to 160 bar as required to maintain the pump supply pressure higher than the final consumer load sensing pressure LSP of 140 bar by the static pressure differential ΔPₛₜ

Table 2 below shows the effect of increasing the pressure Pₛₑₜ of the hydraulic pump supply control HPSCS to include a dynamic pressure differential ΔP_{dyn} of 20 bar when the rate of increase of LSP reaches the threshold value Tr of 5 bar/50 ms.

TABLE 2
Pressure differential increased depending on rate of change of LSP

| | | PSP = ΔPₛₜ + Pₛₑₜ | | | |
|---|---|---|---|---|---|
| | | (where Pₛₑₜ = LSP + ΔP_{dyn}) | | | |
| | | | Pₛₑₜ | | |
| | | | LSP | | PSP |
| | | | at start | | at end |
| | | ΔPₛₜ | of cycle | ΔP_{dyn} | of cycle |
| Cycle | Description | (bar) | (bar) | (bar) | (bar) |
| 1 | Pump pressure is | 20 | 20 | 0 | 40 |
| | 20 bar, valve is | | | (no LSP | |
| | actuated. Pₛₑₜ = | | | gradient | |
| | 20 bar (LSP + | | | initially | |
| | ΔP_{dyn}) | | | available) | |
| | forwarded to pump | | | | |
| | controller, | | | | |
| | pump supply | | | | |
| | pressure is | | | | |
| | adjusted to 40 bar | | | | |
| 2 | Pump pressure is | 20 | 40 | 20 | 80 |
| | 40 bar, valve is | | | (LSP gradient > | |
| | actuated. Pₛₑₜ = | | | 5 bar/5 0 ms) | |
| | 60 bar (LSP + | | | | |
| | ΔP_{dyn}) is | | | | |
| | forwarded to pump | | | | |
| | controller, | | | | |
| | pump supply | | | | |
| | pressure is | | | | |
| | adjusted to 80 bar | | | | |
| 3 | Pump pressure is | 20 | 80 | 20 | 120 |
| | 80 bar, valve is | | | (LSP gradient > | |
| | actuated. Pₛₑₜ = | | | 5 bar/50 ms) | |
| | 100 bar (LSP + | | | | |
| | ΔP_{dyn}) | | | | |
| | is forwarded | | | | |
| | to pump | | | | |
| | controller, pump | | | | |
| | supply pressure | | | | |
| | is adjusted | | | | |
| | to 120 bar | | | | |
| 4 | Pump pressure is | 20 | 120 | 20 | 160 |
| | 120 bar, valve | | | (LSP gradient > | |
| | is actuated. Pₛₑₜ = | | | 5 bar/50 ms) | |
| | 140 bar (LSP + | | | | |
| | ΔP_{dyn}) | | | | |
| | is forwarded to | | | | |
| | pump controller, | | | | |
| | pump supply | | | | |
| | pressure is | | | | |
| | adjusted to 160 bar | | | | |

It can be seen from Table 2 that increasing Pₛₑₜ to include an additional dynamic pressure differential ΔP_{dyn} when the rate of increase of the load sensing pressure LSP reaches the threshold Tr, fewer cycles (four in this case) are required to increase the pump supply pressure PSP to 160 bar using the methods disclosed. This considerably increases the speed of response of the system in adapting the pump supply pressure PSP to meet a rapidly rising consumer load.

In the above example, once application of a dynamic pressure differential ΔP_{dyn} has been triggered by the rate of increase of the load sensing pressure reaching the threshold Tr, the dynamic pressure differential ΔP_{dyn} is applied continuously until the consumer demand is met, that is to say when the pump supply pressure PSP equals the sum of the load sensing pressure LSP, the static pressure differential ΔPₛₜ, and the dynamic pressure differential ΔP_{dyn}. However, in an alternative embodiment, the dynamic pressure differential ΔP_{dyn} is only applied for a limited time period after its application is triggered by the rate of increase of the load sensing pressure LSP reaching the threshold Tr and is then ramped down. The time period over which the dynamic pressure differential ΔP_{dyn} is applied will be referred to as an application period (AP). Applying a dynamic pressure differential ΔP_{dyn} for a time limited application period AP has been found to provide a dynamic response to a rapidly increasing load sensing pressure LSP but in a more efficient way than applying a dynamic pressure differential ΔP_{dyn} continuously. The relatively brief application of a dynamic pressure differential ΔP_{dyn} gives the pump output supply an initial boost to meet the hydraulic load demand but without over supplying the hydraulic system. The application period AP can be selected to meet system requirements but the applicant has found an application period AP in the range of 50 to 300 ms, or in the range of 80 to 200 ms, or in the range of 90 to 150 ms, or in the region of 100 ms to be effective. The system may be configured to apply a dynamic pressure differential ΔP_{dyn} for different application periods AP depending on operational requirements, such as for different consumers.

In embodiments in which the dynamic pressure differential ΔP_{dyn} is applied for a time limited application period AP, the system may also be configured to set a delay period DP following one application of a dynamic pressure differential ΔP_{dyn} before a subsequent application of a dynamic pressure differential ΔP_{dyn} is permitted. The application of a delay period DP between applications of dynamic pressure differential ΔP_{dyn} helps to maintain system stability, reducing the risk that oscillations in a load sensing pressure LSP signal are unduly amplified by the addition of a dynamic pressure differential ΔP_{dyn}. The delay period DP is timed from the point at which a dynamic pressure differential ΔP_{dyn} is first applied. In other embodiments, the delay period DP is timed from the point at which application of a dynamic pressure differential ΔP_{dyn} is stopped. Indeed, the delay period DP can be timed from any suitable point in relation to an application of a dynamic pressure differential ΔP_{dyn}. Once the delay period DP has expired, a dynamic pressure differential ΔP_{dyn} can be applied again for the set application period AP if the operating conditions meet the criteria for application of a dynamic pressure differential ΔP_{dyn}. For example, if at the end of the delay period DP following a one application of a dynamic pressure differential ΔP_{dyn} the rate of increase of the load sensing pressure LSP is at or above the threshold Tr, the controller 102 will again apply a dynamic pressure differential ΔP_{dyn} for a further application period AP and a further delay period DP begins. The delay period DP can be selected to meet system requirements but the applicant has found that if the delay period DP is timed from the start of a dynamic pressure differential ΔP_{dyn} being applied, a delay period DP in the range of 600 to 1400 ms, or in the range of 800 to 1200 ms, or in the region of 1000 ms to be effective. The delay period DP is longer than the application period AP and once a dynamic pressure differential ΔP_{dyn} has been ramped down, no dynamic pressure differential ΔP_{dyn} is applied for at least the remainder of the delay period DP. Thus the delay period DP defines a minimum interval between applications of a dynamic pressure differential ΔP_{dyn}.

In other embodiments, once application of a dynamic pressure differential ΔP_{dyn} is triggered by the rate of increase of the load sensing pressure LSP reaching the threshold Tr, the dynamic pressure differential ΔP_{dyn} is applied continuously until the rate of rate of increase of the load sensing pressure LSP falls below a threshold value Tr*. This threshold value Tr* may be the same as the threshold value Tr which triggers the application of a dynamic pressure differential ΔP_{dyn} or it may be a different value. Again, the system may apply a delay period DP following one application of a dynamic pressure differential ΔP_{dyn} before another application is permitted.

A delay period DP between applications of dynamic pressure differential ΔP_{dyn} can be adopted in any of the embodiments disclosed herein.

The performance of the hydraulic supply system will be influenced by the choice of dynamic pressure differential ΔP_{dyn} and threshold value Tr broadly as follows:

A higher value for the dynamic pressure differential ΔP_{dyn} will increase the system dynamics as it leads to a faster reaction time to change the pump supply pressure PSP once the rate of increase of the consumer load sensing pressure LSP has reached the threshold value. A lower ΔP_{dyn} value would tend to lead to a slower response but perhaps a smoother and less abrupt change in pump supply pressure PSP.

Lowering the threshold value Tr will increase system dynamics as it causes the dynamic pressure differential ΔP_{dyn} to be applied sooner when an increase in load sensing pressure LSP occurs, and a higher threshold will delay application of the dynamic pressure differential ΔP_{dyn} leading to a less dynamic response of the system.

Increasing the dynamic pressure differential ΔP_{dyn} and/or lowering the threshold value Tr of the rate of increase of the load sensing pressure LSP can both be used to provide higher system dynamics. However, use of a lower threshold value Tr is dependent on the ability of the system to sense the load sensing pressure to the tolerances required for reliable control with a smaller threshold value Tr. In view of this it is generally preferred to increase the dynamic pressure differential ΔP_{dyn} in order to increase the dynamic performance of a hydraulic system. However, a lower threshold value Tr can be used to increase system dynamics where the value selected and the system permits reliable operation.

As both the dynamic pressure differential ΔP_{dyn} and the threshold value Tr of the rate of increase of consumer load sensing pressure LSP influence the dynamic behavior of the pump adjustment based on consumer load sensing pressure LSP, they are collectively referred to as “LS dynamic parameters”.

The actual values for the threshold Tr and the dynamic pressure differential ΔP_{dyn} are selected as appropriate to any given hydraulic system and the person skilled in the art will be able to establish suitable values by, for example, trial and error. However, in trials with a typical hydraulic supply system on a tractor having a pump MP with a maximum delivery rate of about 229.5 l/min at an engine speed of 2700 RPM and a maximum pump supply pressure of about 230 bar, the applicant has found that a dynamic pressure differential ΔP_{dyn} in the range of 10 bar to 40 bar and a threshold value Tr in the range of 4 to 10 bar/50 ms are generally suitable. Values outside of these ranges though might also be applicable in some hydraulic systems.

Values for the LS dynamic parameters may be stored in the memory 106 of the tractor controller 102 or be otherwise accessible to the electronic processor 104. LS dynamic parameters may be provided as a default setting permanently saved to the memory 106 or the system may be configured so the values of the LS dynamic parameters can be set or modified via a user interface, such as the touch screen. This would enable the parameters to be input or adjusted by a driver or other user. Where the LS dynamic parameters can be input or modified, this would enable a driver to set the LS dynamic parameters to provide a suitable dynamic performance for a particular job or task and/or enable different values for the parameters to be used for different implements. For example, use of a particular implement may be improved by a more dynamic response, whereas a different type of implement may be better suited to a less dynamic response. The ability to vary the value of one or more of the LS dynamic parameters enables the driver to adapt the hydraulic supply system accordingly. In a further alternative, instead of entering respective values for the threshold Tr and/or the dynamic pressure differential ΔP_{dyn}, the system may be configured to operate in different LS modes which may be optionally selected by a user. The system could, for example, be configured to be operable in a “dynamic mode” or an “efficiency mode”, with the values of the LS dynamic parameters being set to provide a faster response to increases in consumer load sensing pressure LSP in the dynamic mode and to provide a slower response time in efficiency mode to reduce power consumption. The system may be further configured to enable selection of a “balanced mode” with the values of the LS dynamic parameters set in-between the dynamic and efficiency modes. The use of predefined, selectable modes require less skill and experience by the driver while still providing an ability to customize the hydraulic supply system settings.

In a further optional refinement, the method may utilize more than one threshold value Tr for the rate of increase of load sensing pressure LSP and more than one dynamic pressure differential ΔP_{dyn} so as to enable a stepped ramp up of the dynamic pressure differential ΔP_{dyn} depending on the rate of increase of the load sensing pressure LSP. Accordingly, in an embodiment the system may configured to apply a first dynamic pressure differential Δp1_{dyn}, for example 20 bar, when the rate of increase of the load sensing pressure LSP is at or above a first threshold value Tr1 but below a second threshold value Tr2, and to apply a higher, second dynamic pressure differential ΔP2_{dyn}, for example 40 bar, when the rate of increase of the load sensing pressure LSP is at or above the second threshold value Tr2. For example, a first threshold value Tr1 could be set at 5 bar/50 ms and a second threshold value Tr2 set at 10 bar/50 ms. It will be appreciated that the values for Tr1, Tr2, ΔP1_{dyn}, and ΔP2_{dyn} mentioned above are illustrative only and that the values used can be selected as desired to suit any particular hydraulic supply system and performance requirements. It should also be appreciated that more than two different dynamic pressure differentials can be utilized and implemented at suitable threshold values for the rate of increase of the load sensing pressure.

In a yet still further optional refinement, different settings for the LS dynamic parameters are adopted depending on the value of the load sensing pressure LSP. For example, a first dynamic pressure differential ΔP1_{dyn} and/or threshold value Tr1 for the LSP pressure gradient is/are applied when the load sensing pressure LSP is below a first threshold pressure TP1 and a second dynamic pressure differential ΔP2_{dyn} and/or threshold value Tr2 for the LSP pressure gradient is/are applied if the load sensing pressure LSP is equal to or above the first threshold pressure TP1. In an embodiment, the LS dynamic parameters may be selected to provide a less dynamic response at higher load sensing pressures. Thus the LS dynamic parameters can be set to provide a fast reaction initially (e.g. to overcome internal inertia in the pump controller when starting to pivot the pump) but then provide a smoother control of the pump supply pressure as the dynamic behavior of the pump increases. This also provides a tiered dynamic response and it will be appreciated that more than two ranges of load sensing pressure LSP in which different LS dynamic parameters are adopted can be defined. In one example, different LS dynamic parameters are applied in two ranges:

Range 1: a first dynamic pressure differential ΔP1_{dyn}, such as 10-20 bar, is applied when the rate of increase of the load sensing pressure is at or above a threshold value Tr1 of 7 bar/50 ms and the load sensing pressure LSP is below a first pressure threshold TP1, such as 40-45 bar.

Range 2: a second dynamic pressure differential ΔP2_{dyn}, such as 5-10 bar, is applied when the rate of increase of the load sensing pressure is at or above a second threshold value Tr2 of 5 bar/50 ms and the load sensing pressure LSP at or above the first pressure threshold TP1, such as 40-45 bar.

It will be noted that the threshold value Tr1 of the rate of increase of the load sensing pressure is slightly higher in the first range than the second range. The means that the system will wait for a higher increase per time of the load sensing pressure LSP before applying the first dynamic pressure differential ΔP1_{dyn}. Nevertheless, since the dynamic pressure differential ΔP1_{dyn} applied in the first range is significantly higher than that applied in the second range, the dynamic response is higher overall in the first range than the second. In tests it has been found that the control system is less prone to oscillation by applying a slightly higher threshold value Tr initially. However, there may be circumstances in which the threshold Tr for the load sensing pressure LSP gradient is the same in all LSP pressure ranges or in which a lower threshold Tr is used for a range in which the LSP pressure is lower than in a later range in which the LSP pressure is higher.

Additional ranges could be added with a second, a third or more threshold pressures TP2, TP3, . . . . TPn with a different dynamic pressure differentials ΔP23_{dyn}, ΔP4_{dyn}, . . . . ΔPn_{dyn} and/or threshold value(s) Tr for the LSP pressure gradient being applied in each range.

In one embodiment, no dynamic pressure differential ΔP_{dyn} is applied once the LSP reaches a threshold pressure TP. Thus in the above example, in a third range in which the LSP pressure is at or above a threshold value TP2 of 70 bar, no dynamic pressure differential ΔP_{dyn} is applied regardless of the rate of increase of the load sensing pressure LSP.

The actual values for the dynamic pressure differential(s) ΔP1_{dyn}, ΔP2_{dyn}, the threshold value(s) Tr for the LSP pressure gradient, and threshold pressure(s) TP can be selected to meet system requirements and are not limited to the above examples.

In an embodiment, the controller 102 is configured to require that the conditions for a particular range are met for a set period of time, referred to as a range delay period RDP, before a dynamic pressure differential ΔP_{dyn} for that range is applied. The range delay period RDP may be in the region of 150 to 450 ms, or in the range of 200 to 400 ms, or in the range of 250 to 350 ms, for example. Thus if the system is operating in range 1 and the load sensing pressure LSP increases to or above the threshold value TP1 indicating a change to range 2, the controller 102 waits for the range delay period RDP to expire before the dynamic pressure differential ΔP2_{dyn} for range 2 can be applied. During this time delay, no dynamic pressure differential ΔP_{dyn} is applied to control the output of the pump. If after expiry of the range delay period RDP the conditions for range 2 are still met, the dynamic pressure differential ΔP2_{dyn} for range 2 is adopted and can be applied if the appropriate threshold Tr2 for the load sensing pressure LSP gradient in that range is met. However, if during the range delay period RDP the load sensing pressure LSP indicates a further change of range, such as back to range 1, a further range delay period RDP is applied from the moment the new range is triggered before the dynamic pressure differential ΔP1_{dyn} for the new range can be applied.

If the system is configured to apply a dynamic pressure differential ΔP_{dyn} for a limited application period AP when triggered and to apply a minimum delay period DP between applications of a dynamic pressure differential ΔP_{dyn}, the system can be configured to apply both a minimum delay period DP and a range delay period RDP. In this case, the controller 102 may be configured to apply the delay period DP and the range delay period RDP concurrently should a change of range occur while a delay period DP is still running following an earlier application of dynamic pressure differential ΔP_{dyn} in the previous range. Typically, the delay period DP will be longer than the range delay period RDP.

To further clarify concurrent running of the delay period DP the range delay period RDP, two examples are considered in which the delay period DP is set to 1000 ms and the range delay period RDP is set to 300 ms. In the examples, a change from range 2 to range 1 takes place after the dynamic pressure differential ΔP2_{dyn} for range 2 has been applied but before the end of the delay period DP triggered by that application.

In a first example, the change of range takes place 600 ms after the delay period DP began. In this case, the range delay period RDP ends 900 ms after the delay period DP had begun. Accordingly, when the delay period DP expires after 1000 ms, the LS dynamic parameters for range 1 are adopted and the dynamic pressure differential ΔP1_{dyn} for range 1 can be applied, provided the conditions for range 1 are still met and the rate of increase of the load sensing pressure is at or above the threshold value Tr1 for range 1 at the time. If the dynamic pressure differential ΔP1_{dyn} is subsequently applied, this will be applied for the application period AP and a further delay period DP is commenced.

In a second example the change in range takes place 800 ms after the delay period DP has begun. In this case, the delay period DP expires 100 ms before the end of the range delay period RDP. Accordingly, application of the LS dynamic parameters for range 1 is delayed for a further 100 ms after the end of the delay period DP. After the range delay period RDP has expired (1100 ms after the previous application of dynamic pressure differential ΔP2_{dyn} when the system was operating in range 2) the dynamic pressure differential ΔP1_{dyn} for range 1 can be applied, provided the conditions for range 1 are still met and the rate of increase of the load sensing pressure is at or above the threshold value Tr1 for range 1 at the time. If the dynamic pressure differential ΔP1_{dyn} is applied, this will be applied for the application period AP and a further delay period DP is commenced.

Should a change of range occur during the application period AP, the controller continues to apply the dynamic pressure differential ΔP_{dyn} until the end of the application period AP. The controller will also concurrently apply the delay period DP and the range delay period RDP before any further dynamic pressure differential ΔP_{dyn} is applied.

Use of the delay periods in this way helps to maintain system stability when changing between ranges and smooths reaction when a range is maintained.

It is expected that varying the LS dynamic parameters in discreet ranges of load sensing pressure LSP will offer smoother control with less risk of oscillation. However, in some systems, the LS dynamic parameters may be varied in proportion (e.g. a linear or other mathematical relationship) to the value of pressure of the load sensing pressure LSP, at least over a certain range of pressures.

### Damping of E-LS System

In order to avoid excessive oscillation and instability of the electronic load sensing E-LS system and in particular to avoid excessive oscillation of the pump controller 66, the system is damped. However, in order to reduce the adverse effects of such damping on the reaction time to increase the pump supply pressure PSP in response to a rising load sensing pressure demand LSP, different degrees or type of damping are applied depending on whether the system is reacting to an increasing load sensing pressure LSP or a decreasing load sensing pressure LSP.

For better understanding, signal processing is briefly described again.

The electronic load sensing pressure signals ELSPS are derived from pressure sensors 122, 124, 125, 126, 128, 130. In an embodiment, the pressure sensors generate an analogue pressure signal in which the current encodes the load sensing pressure LSP. The controller 102 determines the pressure value of the sensed load sensing pressure LSP from the ELSPS, such as by reference to a characteristic map assigned to the sensor. In other embodiments, the voltage of the ELSPS may encode the load sensing pressure. In further embodiments, the ELSPS is converted to a pressure value at the sensor, which forwards the pressure value for the load sensing pressure LSP to the controller via a CAN interface or the like. In either embodiment, the controller 102 calculates a target set point pressure value Pₛₑₜ for controlling the pump supply pressure based on the sensed load sensing pressure LSP. The controller converts the target set point pressure value Pₛₑₜ into an electronic pump supply control signal EPSCS (typically a current value) to actuate the solenoid of the pressure limiting valve 54 in order to generate a hydraulic pump supply control signal HPSCS having a pressure at the target set point pressure value Pₛₑₜ to vary the output of the main pump as explained above with reference to FIG. 3. The pump supply pressure PSP will be adjusted to a pressure which equals the target set point pressure value Pₛₑₜ plus the static pressure differential ΔPₛₜ provided by the spring 22 in valve 22′

In one embodiment, damping is applied as part of the process for determining the target set point pressure value Pₛₑₜ based in the load sensing pressure LSP value. In one embodiment, dampening is only applied when the load sensing pressure LSP is falling and not when the load sensing pressure LSP is rising. The applicant has found that this arrangement enables the E-LS control system to remain stable without significantly increasing the reaction time in raising the pump supply pressure to meet an increased load demand.

In an embodiment, the controller 102 is configured and programed to use a low pass filter to damp the response of the E-LS system in adjusting the pump supply pressure when the electronic load sensing pressure signal ELSPS is indicative of a falling load sensing pressure LSP. In one embodiment, a low pass filter of first order according to the following equation is used:

$${y}_{n + 1} = {y}_{n} + \frac{Δ t}{Δ t + Tm} * ( K * {u}_{n + 1} - {y}_{n} ) n = ( 0 , 1 , 2 , ... {n}_{max} ) \qquad Equation 4$$

### Wherein:

| Common | Variable | |
|---|---|---|
| Variable | used | Description |
| yₙ | P_{set, n} | Target set point pressure |
| | | value of the previous cycle |
| yₙ₊₁ | P_{set, n+1} | Target set point pressure |
| | | value of the current cycle |
| uₙ₊₁ | PLSP, ₙ₊₁ | A pressure value which includes |
| | | or is based on the load |
| | | sensing pressure LSP of |
| | | the current cycle |
| Δt | | cycle time |
| Tm | | time constant |
| K | | constant |

Rewriting Equation 4 with the specific variables according this embodiment gives:

$${P}_{set , n + 1} = {P}_{set , n} + \frac{Δ t}{Δ t + Tm} * ( K * {PLSP}_{, n + 1} - {P}_{set , n} ) n = ( 0 , 1 , 2 , ... {n}_{max} ) \qquad Equation 5$$

In a non-limiting embodiment, cycle time Δt is 20 ms, time constant Tm is set at 500 ms and the constant K is set at 1. Rewriting equation 5 to include the predefined constants gives:

$${P}_{set , n + 1} = {P}_{set , n} + \frac{20 ms}{20 ms + 500 ms} * ( 1 * {PLSP}_{, n + 1} - {P}_{set , n} ) n = ( 0 , 1 , 2 , … {n}_{max} ) \qquad Equation 6$$

The values for cycle time Δt and time constant Tm can be varied depending on system requirements. For example, cycle time Δt could be in the range of 18 ms to 22 ms and time constant Tm could be in the range of 350 ms to 550 ms. Values outside of these ranges may also be useful.

In an alternative embodiment, damping is applied for both rising and falling load sensing pressure LSP but differing damping characteristics are applied when the load sensing pressure LSP is rising than when the load sensing pressure LSP is falling. The differing damping characteristics are selected to produce a smaller delay in adjusting the pump supply pressure for a rising load sensing pressure LSP when compared to the delay for a falling pressure signal. To this end, the system is damped more aggressively, or more strongly, when the load sensing pressure LSP is falling than when the load sensing pressure LSP is rising.

For example, in the low pass filter described above with reference to equations 4 to 6, the larger the time constant Tm, the greater the delay introduced into the system. Thus in an embodiment, the same low pass filter is applied for both a rising and falling load sensing pressure LSP but with a smaller time constant Tm used when the system is responding to a rising load sensing pressure LSP than when it is responding to a falling load sensing pressure LSP. This has the effect that the increase in reaction time to adjust the pump supply pressure caused by damping of the system is lower for a rising load sensing pressure LSP than for a falling load sensing pressure LSP. This helps to maintain the dynamic response of the system in responding to an increase in load demand while maintaining stability of the control system.

In a non-limiting example, when the load sensing pressure LSP is rising a time constant Tm in the region of 45 ms to 55 ms, and more particularly in the region of 50 ms can be used. Putting these values into equation 5 gives:

$${P}_{set , n + 1} = {P}_{set , n} + \frac{20 ms}{20 ms + 50 ms} * ( 1 * {PLSP}_{, n + 1} - {P}_{set , n} ) n = ( 0 , 1 , 2 , … {n}_{max} ) \qquad Equation 7$$

Values for time constant Tm outside of the range mentioned above may also be useful.

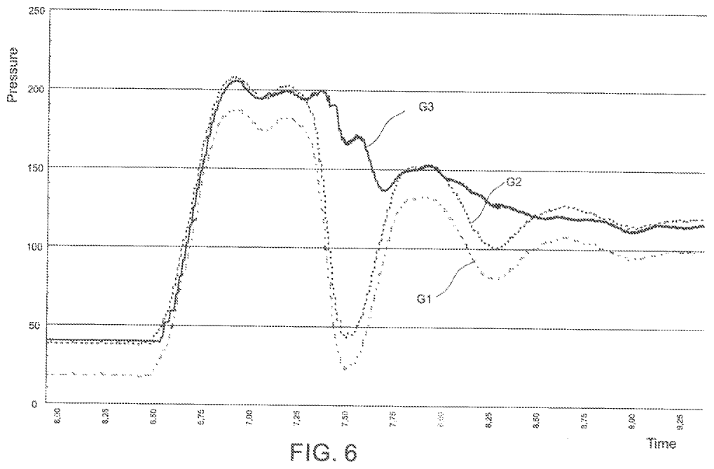

The effect of the above damping arrangements will be described with reference to FIG. 6, in which: line G1 illustrates the load sensing pressure LSP reported by a pressure sensor derived as a raw signal without any post processing, line G2 shows the determined pump supply pressure set value P_{set,undamped} when no damping is applied, and line G3 shows the determined pump supply pressure set value P_{set,damped} when damping is applied according the above embodiments.

As illustrated by line G1, the load sensing pressure LSP and hence the electronic load sensing pressure signal ELSPS tends to reflect relatively high fluid oscillations imprinted by the consumers, especially when the consumers are rotatory hydraulic drives, such as vane, gear or piston type motors. The oscillations especially occur in a condition where the pressure inside these drives drops and the load sensing pressure LSP is falling, as shown with reference to the time period from 7,00 onwards.

Without damping, the pump supply pressure set value P_{set,undamped} depicted by line G2 strictly follows the load sensing pressure LSP. This would cause the E-LS system to adjust the pump supply very quickly in response to a rising load sensing pressure LSP demand but follow the oscillations of the load sensing pressure LSP when demand pressure drops (falling load sensing pressure LSP). This causes oscillations with high amplitude in the pump controller.

When damping is applied according to the embodiments described above where a rising load sensing pressure is undamped or damped less vigorously, such as according to Equation 7, the pump supply pressure set value P_{set,damped} illustrated by line G3 reacts very quickly to increasing LS demands enabling the pump supply pressure PSP to be increased quickly to meet the demand. However, with increased damping applied when the load sensing pressure LSP is falling, such as according to Equation 6, the pump supply pressure set value P_{set,damped} as illustrated by line G3 shows a reduced number of oscillations with smaller amplitude and reaches a smooth curve earlier compared with line G2. This reduces the number and amplitude of the oscillations in the pump controller.

The variable PLSPₙ₊₁ used in equations 5 to 7 is a pressure value which includes or is based on the load sensing pressure LSP detected at the time. Where the E-LS system adjusts the pump supply pressure PSP in dependence on the value of the load sensing pressure without taking into account the rate of increase of the load sensing pressure, then PLSPₙ₊₁ will generally be equal to the load sensing pressure LSP. However, where the E-LS system is configured to apply an additional dynamic pressure differential ΔP_{dyn} when the rate of increase of the load sensing pressure LSP is at or above a threshold value Tr, then, according to an embodiment, any dynamic pressure differential ΔP_{dyn} to be applied is added to the load sensing pressure LSP before damping so that PLSPₙ₊₁ in equation 5 will be equal to the load sensing pressure LSP plus the dynamic pressure differential ΔP_{dyn} such that:

$${PLSP}_{n + 1} = LSP + Δ {P}_{dyn} \qquad Equation 8$$

Indeed, the control system can be configured to add any required additional pressure differential which is to be electronically generated through E-LS system to the load sensing pressure LSP prior to damping.

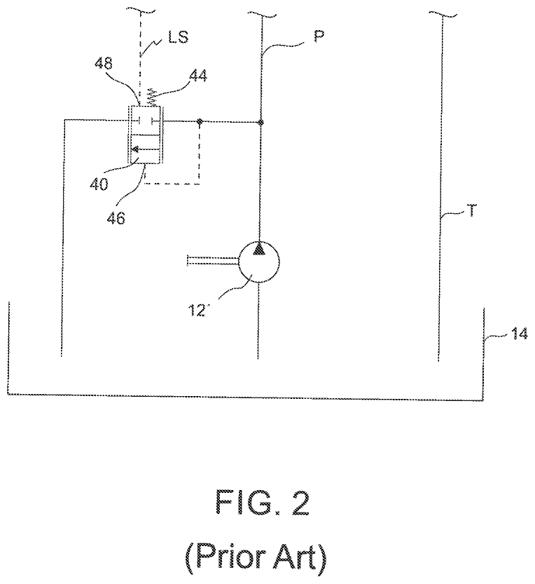

Various modifications to the systems and methods according to the disclosure will be apparent to those skilled in the art. For example, the main pump MP may be a fixed displacement pump and the pump supply may be configured as illustrated in FIG. 2. In this case, the pump supply pressure PSP is regulated by directing a hydraulic LS pump supply control signal Pₛₑₜ from a solenoid controlled pressure limiting valve 54 to the load sensing port 48 of the proportional pressure compensator valve 40. The solenoid controlled pressure limiting valve 54 being controlled by the electronic pump supply control signal EPSCS from the tractor controller 102.

1. A control system for controlling a hydraulic supply system on a mobile machine, wherein the hydraulic supply system includes a pump supply for supplying a pressurized fluid to a plurality of consumers carried by the mobile machine;
the control system comprising at least one controller configured to: receive, from a pressure sensor of a load sensing system associated with at least
one of the consumers, a pressure signal indicative of a sensed load sensing pressure (LSP) associated with the at least one of the consumers;
determine whether the LSP is rising or falling; and
compute and generate a control signal for regulating a pump supply pressure provided by the pump supply in dependence on the sensed LSP;
wherein the at least one controller is configured to dampen a control system response to changes in the LSP, and wherein the at least one controller is configured to apply different damping characteristics when the LSP is rising than when the LSP is falling.

2. The control system of claim 1, wherein the at least one controller is configured to dampen the control system response to changes in the LSP only when the LSP is falling, such that the control system response to changes in the LSP is undamped LSP is rising.

3. The control system of claim 1, wherein the at least one controller is configured to dampen the control system response to changes in the LSP more strongly when the LSP is falling than when the LSP is rising.

4. The control system of claim 1, wherein the at least one controller is configured to dampen the control system response to changes in the LSP by applying a digital low pass filter.

5. The control system of claim 4, wherein the low pass filter is a first order filter.

6. The control system of claim 1, wherein the at least one controller is configured to dampen the control system response to changes in the LSP by applying the following equation when determining a target set pressure value Pₛₑₜ for adjusting the pump supply pressure in dependence on the load sensing pressure LSP:
$${P}_{set , n + 1} = {P}_{set , n} + \frac{Δ t}{Δ t + Tm} * ( K * {PLSP}_{, n + 1} - {P}_{set , n} ) n = ( 0 , 1 , 2 , … {n}_{max} ) ;$$
wherein:
P_{set,n}=the target set point pressure value Pₛₑₜ of the previous cycle;
P_{set,n+1}=the target set point pressure value Pₛₑₜ for the current cycle;
PLSPₙ₊₁=a pressure value based on or including the sensed LSP of the current cycle;
Δt=cycle time;
Tm=time constant; and
K=a constant.

7. The control system of claim 6, wherein the at least one controller is configured to apply a higher time constant Tm when the LSP is falling than when the LSP is rising.

8. The control system of claim 6, wherein, for a falling LSP:
Δt is between 18 and 22 ms, inclusive;
Tm is between 350 and 550 ms, inclusive; and
K=1.

9. The control system of claim 6, wherein for a rising LSP:
Δt is between 18 and 22 ms, inclusive;
Tm is between 45 and 55 ms, inclusive; and
K=1.

10. A mobile machine comprising a hydraulic supply system including a pump supply for supplying a pressurized fluid to a plurality of consumers carried by the mobile machine and a control system for controlling the hydraulic supply system as claimed in claim 1.

11. A method of controlling a hydraulic supply system on a mobile machine, wherein the hydraulic supply system includes a pump supply for supplying a pressurized fluid to a plurality of consumers carried by the mobile machine, the hydraulic supply system comprising an electronic load sensing (E-LS) system, the E-LS system configured to adjust the pump supply pressure in dependence on the sensed load sensing pressure LSP, wherein the method comprises dampening adjustment of the pump supply pressure PSP in response to changes in the LSP, and wherein the method comprises applying different damping characteristics depending on whether the LSP is rising or falling.

12. The method of claim 11, further comprising dampening adjustment of the PSP in response to a falling LSP and leaving adjustment of the PSP undamped in response to a rising LSP.

13. The method of claim 11, further comprising dampening adjustment of the PSP in response to changes in the LSP more strongly when the LSP is falling than when the LSP is rising.

14. The method of claim 11, wherein the method comprises dampening adjustment of the PSP in response to changes in the LSP by applying a digital low pass filter.

15. The method of claim 14, wherein the low pass filter is a first order filter.

16. The method of claim 11, wherein the method comprises determining a target set point pressure value Pₛₑₜ for adjusting the PSP in dependence on the LSP in accordance with the following equation:
$${P}_{set , n + 1} = {P}_{set , n} + \frac{Δ t}{Δ t + Tm} * ( K * {PLSP}_{, n + 1} - {P}_{set , n} ) n = ( 0 , 1 , 2 , … {n}_{max} ) ;$$
wherein:
P_{set,n}=the target set point pressure value Pₛₑₜ of the previous cycle;
P_{set,n+1}=the target set point pressure value Pₛₑₜ for the current cycle;
PLSPₙ₊₁=a pressure value based on or including the sensed LSP of the current cycle;
Δt=cycle time;
Tm=time constant; and
K=a constant.

17. The method of claim 16, wherein the method comprises applying a higher time constant Tm when the LSP is falling than when the LSP is rising.

18. The method of claim 16, wherein, for a falling LSP:
Δt is between 18 and 22 ms, inclusive;
Tm is between 350 and 550 ms, inclusive; and
K=1.

19. The method of claim 16, wherein for a rising LSP:
Δt is between 18 and 22 ms, inclusive;
Tm is between 45 and 55 ms, inclusive; and
K=1.

20. The mobile machine of claim 10, wherein the plurality of consumers comprises at least one selected from the group consisting of a consumer on the mobile machine and an implement attached to the mobile machine.
